(19) United States
(12) Patent Application Publication
(10) Pub. No.: US 2014/0333774 A1
(43) Pub. Date: Nov. 13, 2014

(54) MULTI-VIEW SURVEILLANCE CAMERA

(71) Applicant: Chen-Shun Hsu, Taipei City (TW)

(72) Inventor: Chen-Shun Hsu, Taipei City (TW)

(21) Appl. No.: 14/266,976

(22) Filed: May 1, 2014

(30) Foreign Application Priority Data
May 8, 2013 (TW) 102208502

(51) Int. Cl. H04N 7/18

(52) U.S. Cl. CPC H04N 7/181
USPC 348/159

(57) ABSTRACT

A multi-view surveillance camera has a body and multiple camera units. The body has a camera-mounting shaft mounted in the body. A first axis is defined along an axial direction of the camera-mounting shaft. The camera units are rotatably mounted on the camera-mounting shaft and are rotatable with respect to the first axis. Accordingly, the multi-view surveillance camera alone can record video from different perspectives, thereby reducing the quantity of surveillance camera to be mounted and eliminating the mounting location limitation of multiple surveillance cameras in a same venue.

### BACKGROUND OF THE INVENTION

1. Field of the Invention

The present invention relates to a surveillance camera, and more particularly to a multi-view surveillance camera capable of taking video from multiple perspectives.

2. Description of the Related Art

Video surveillance systems prevail in all sorts of private residences or public buildings because of the capability of constantly monitoring movement of people at various sites in an attempt to lower the occurrence of theft, burglary and other hazardous events and gathering evidences for accountability and liability.

Regular indoor venues, such as supermarkets, stores and the like, normally employ stationary surveillance cameras. With reference to FIG. 5, each conventional stationary surveillance camera 90 has a camera 91 taking video streams in only one direction. To reduce the dead zone of the stationary surveillance camera 90, the stationary surveillance camera 90 is usually mounted at a corner of a venue. If the shooting coverage of the stationary surveillance camera already installed in the venue is not enough, more stationary surveillance cameras are required to record in different directions. Thus, the equipment cost and labor required for installing the stationary surveillance camera fails to meet the price-effective concern. The aesthetic appeal of the venue can be also affected. Besides, preferred shooting locations for multiple surveillance cameras mounted in a same venue may not always be available at the same time, and a restricted shooting coverage arises from the limitation. Furthermore, the stationary surveillance camera 90 in FIG. 5 is preferably mounted at a top right corner, and another stationary surveillance camera 90′ mounted elsewhere is prone to blockage of the walls, which results in several dead zones as illustrated in the slash areas.

### SUMMARY OF THE INVENTION

An objective of the present invention is to provide a multi-view surveillance camera capable of taking video from multiple perspectives.

To achieve the foregoing objective, the multi-view surveillance camera has a body and multiple camera units.

The body has a camera-mounting shaft mounted in the body. A first axis is defined along an axial direction of the camera-mounting shaft.

The camera units are rotatably mounted on the camera-mounting shaft and are rotatable with respect to the first axis.

When the foregoing multi-view surveillance camera is operated, the body of the multi-view surveillance camera can be mounted at a location with a preferred shooting perspective, and the camera units can be turned to direct to different directions for recording videos. Accordingly, the multi-view surveillance camera can simultaneously record videos from different perspectives, thereby reducing the quantity of surveillance camera to be mounted and mitigating the adverse effects on equipment cost, labor for mounting, and aesthetic appeal of the site for mounting. Besides, the mounting location limitation against multiple surveillance cameras mounted in a same venue can be also eliminated.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a multi-view surveillance camera in accordance with the present invention;

FIG. 2 is a side view of the multi-view surveillance camera in FIG. 1;

FIG. 3 is a top view of the multi-view surveillance camera in FIG. 1;

FIG. 4 is an operational schematic view of the multi-view surveillance camera in FIG. 1; and

FIG. 5 is an operational schematic view of conventional stationary surveillance cameras.

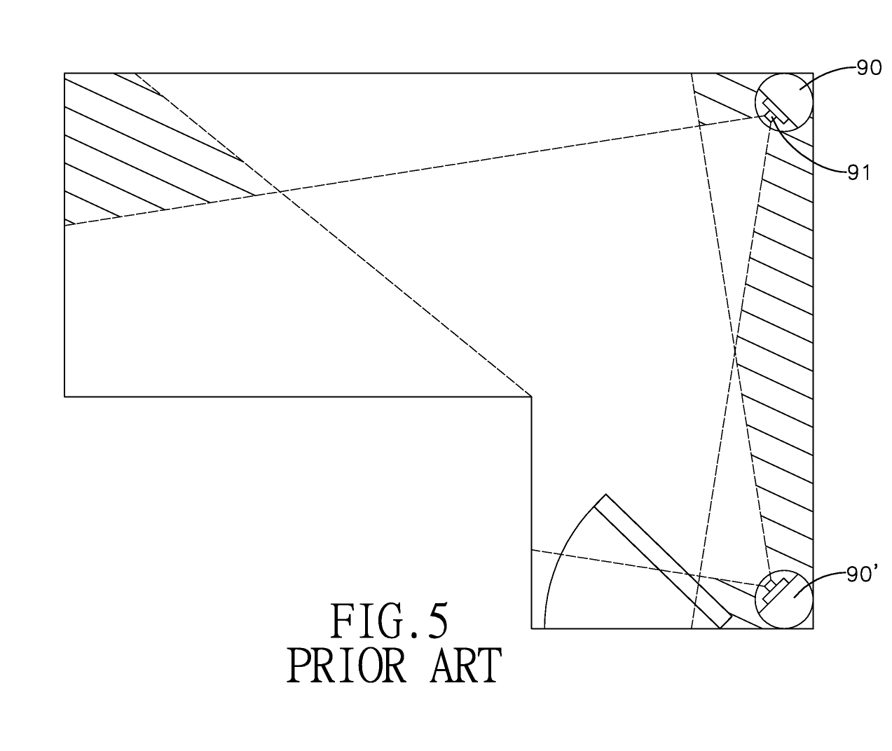

### DETAILED DESCRIPTION OF THE INVENTION

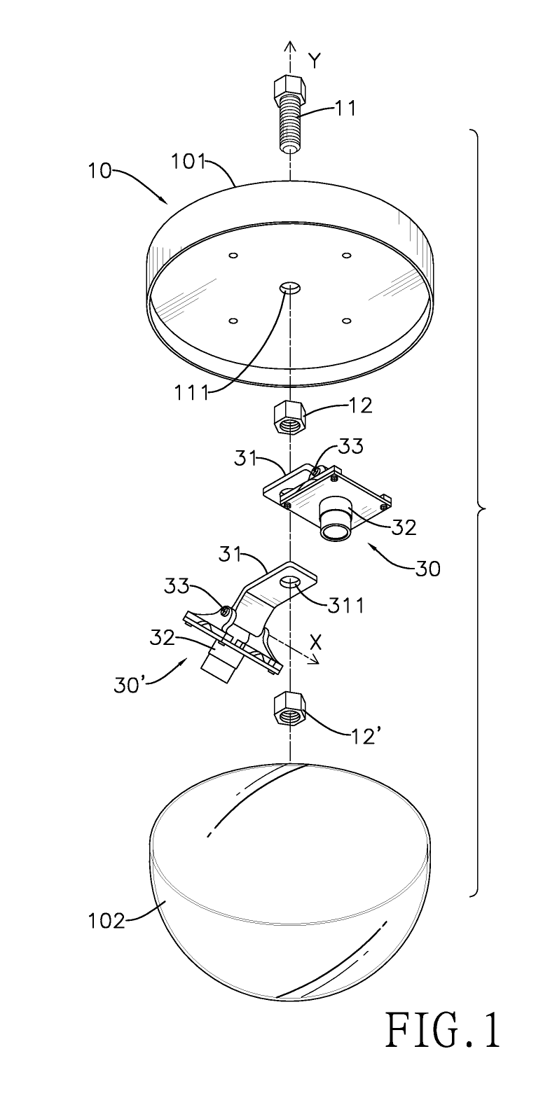

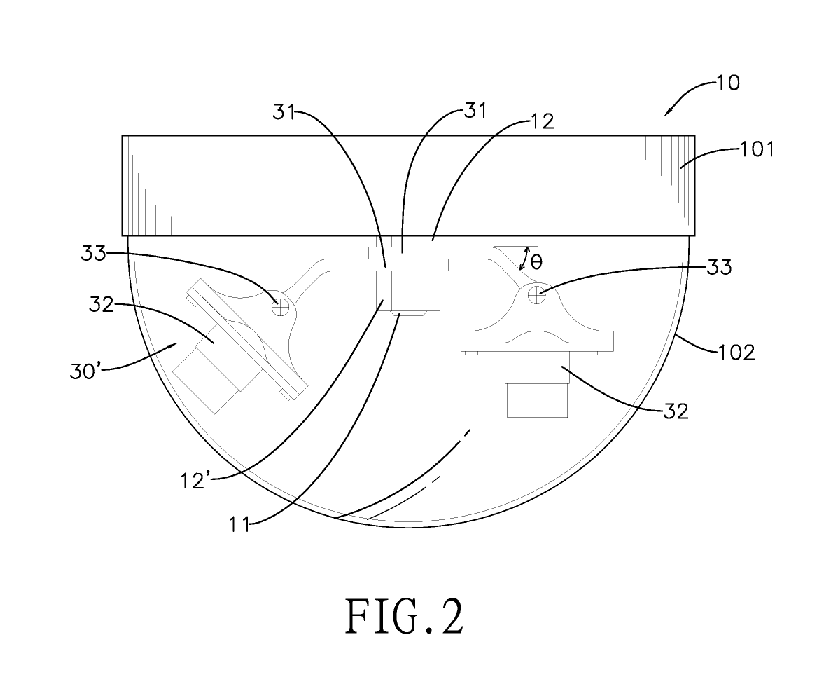

With reference to FIGS. 1 and 2, a multi-view surveillance camera in accordance with the present invention has a body 10 and multiple camera units 30, 30′.

The body 10 has a camera-mounting shaft 11, a base 101 and a shield cover 102. The camera-mounting shaft 11 is mounted in the body 10. A first axis Y is defined along an axial direction of the camera-mounting shaft 11. The base 101 has a top and a bottom. The shield cover 102 is mounted around a circumferential edge of the bottom of the base 101 to cover the bottom of the base 101. The camera-mounting shaft 11 may be a stud sequentially mounted through the top and the bottom of the base 101. After being mounted in the base 101, the stud is fastened to the base 101 by engaging a nut 12.

The camera units 30, 30′ are rotatably mounted on the camera-mounting shaft 11, are enclosed by the base 101 and the shield cover 102, and are rotatable with respect to the first axis Y. Each camera unit 30, 30′ has a bracket 31 and a camera 32. The bracket 31 has a camera-mounting hole 311 formed through a first end of the bracket 31. A diameter of the camera-mounting hole 311 matches a diameter of the camera-mounting shaft 11 for the bracket 31 to be fastened on an inner end of the camera-mounting shaft 11 by thread engagement with another nut 12′. The bracket 31 is perpendicular to the first axis Y. The camera 32 is pivotally mounted on a second end of the bracket 31 through a pivot axis 33 being not parallel to the first axis Y, passing through the camera 32 and the second end of the bracket 31, and defined as a second axis X. In the present embodiment, the second axis X is perpendicular to the first axis Y. To expand a shooting coverage of the camera unit 30, the second end of the bracket 31 pivotally connected to the camera 32 is tilted down at an oblique angle θ.

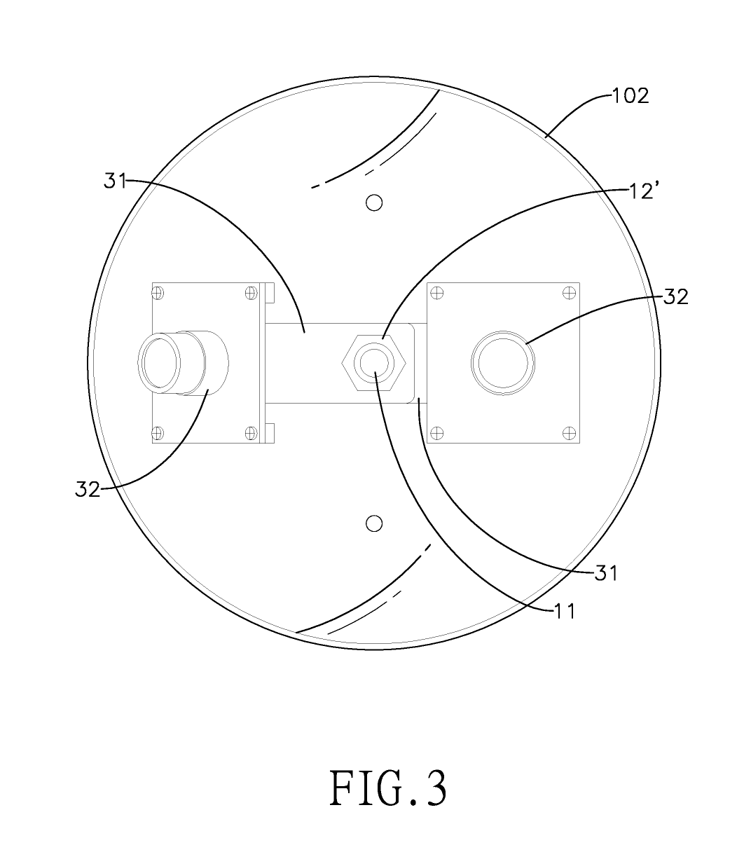

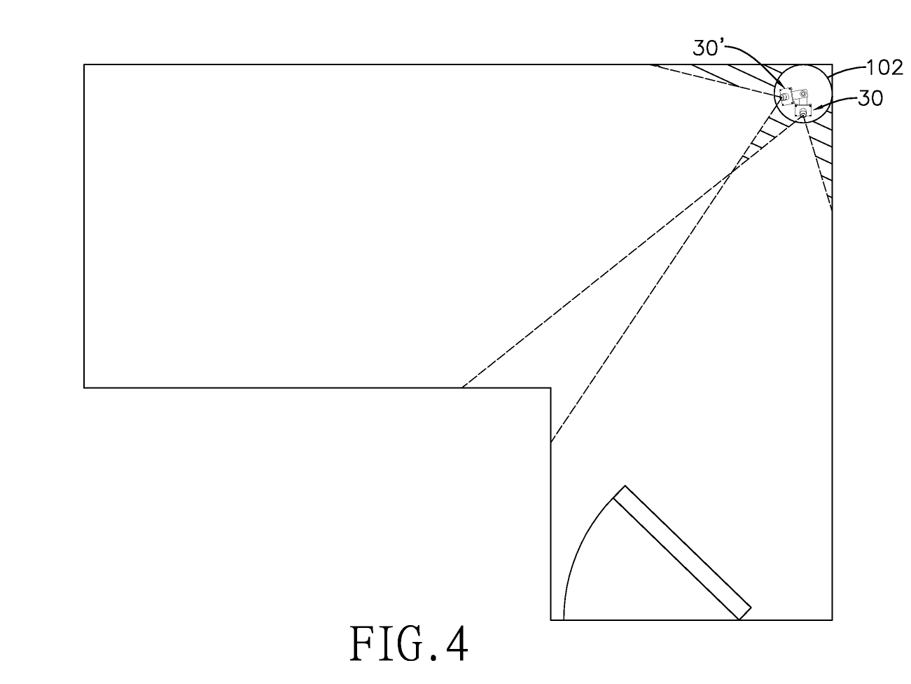

Operation of the multi-view surveillance camera is shown in FIGS. 3 and 4. As the multi-view surveillance camera in accordance with the present invention can simultaneously record video streams in multiple different directions, the quantity of the multi-view surveillance camera can be reduced. When being mounted in a venue with a particular layout, the multi-view surveillance camera is less likely to be limited as far as desired mounting location is concerned. With reference to FIG. 4, the multi-view surveillance camera is preferably mounted at a top right corner with two camera units 30, 30′ respectively directing to two different directions for recording. Compared with conventional stationary surveillance cameras mounted at two different corners, the multi-view surveillance camera provides a broader shooting coverage with smaller dead zone.

When there are two camera units 30, the brackets 31 of the camera units 30 can be rotated with respect to the first axis Y and aligned in two different directions before being securely fastened by the nut 12′. Then, the cameras 32 of the camera units 30 are respectively turned with respect to the pivot axis 33, i.e. the second axis X, to orient to two different directions, such that the multi-view surveillance camera alone can simultaneously record video streams in two different directions.

To further expand the shooting coverage of the multi-view surveillance camera, the multi-view surveillance camera can be equipped with more camera units 30. Suppose that the multi-view surveillance camera has three camera units 30. The brackets 31 of the three camera units are mounted on the camera-mounting shaft 11, and the cameras 32 of the camera units can be directed to three different directions for recording. As the camera-mounting shaft 11 can be mounted through different camera units 30, the multi-view surveillance camera can have as many camera units 30 as the space inside the body 10 allows to expand the shooting coverage.

In sum, the multi-view surveillance camera in accordance with the present invention can record video streams from multiple different perspectives, thereby reducing the quantity of surveillance camera to be mounted and mitigating the adverse effects on equipment cost, labor for mounting, and aesthetic appeal of the site for mounting. Additionally, the mounting location limitation against multiple surveillance cameras mounted in a same venue can be also eliminated.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multi-view surveillance camera, comprising:
a body having a camera-mounting shaft mounted in the body, wherein a first axis is defined along an axial direction of the camera-mounting shaft; and
multiple camera units rotatably mounted on the camera-mounting shaft and being rotatable with respect to the first axis.

2. The multi-view surveillance camera as claimed in claim 1, wherein each camera unit has
a bracket having a camera-mounting hole formed through a first end of the bracket, wherein a diameter of the camera-mounting hole matches a diameter of the camera-mounting shaft for the bracket to be mounted on the camera-mounting shaft, the bracket being perpendicular to the first axis; and
a camera pivotally mounted on a second end of the bracket through a pivot axis being not parallel to the first axis, passing through the camera and the second end of the bracket, and defined as a second axis.

3. The multi-view surveillance camera as claimed in claim 2, wherein the second axis is perpendicular to the first axis.

4. The multi-view surveillance camera as claimed in claim 2, wherein the body has
a base having a top and a bottom; and
a shield cover mounted around a circumferential edge of the bottom of the base to cover the bottom of the base.

5. The multi-view surveillance camera as claimed in claim 3, wherein the body has
a base having a top and a bottom; and
a shield cover mounted around a circumferential edge of the bottom of the base to cover the bottom of the base.

6. The multi-view surveillance camera as claimed in claim 4, wherein
the camera-mounting shaft is a stud sequentially mounted through the top and the bottom of the base and fastened on the base by a nut; and
the bracket is fastened on the stud by another nut engaging an inner end of the stud.

7. The multi-view surveillance camera as claimed in claim 5, wherein
the camera-mounting shaft is a stud sequentially mounted through the top and the bottom of the base and fastened on the base by a nut; and
the bracket is fastened on the stud by another nut engaging an inner end of the stud.

8. The multi-view surveillance camera as claimed in claim 4, wherein the second end of the bracket pivotally connected to the camera is tilted down at an oblique angle.

9. The multi-view surveillance camera as claimed in claim 5, wherein the second end of the bracket pivotally connected to the camera is tilted down at an oblique angle.

10. The multi-view surveillance camera as claimed in claim 6, wherein the second end of the bracket pivotally connected to the camera is tilted down at an oblique angle.

11. The multi-view surveillance camera as claimed in claim 7, wherein the second end of the bracket pivotally connected to the camera is tilted down at an oblique angle.
